(19) United States
(12) Patent Application Publication
(10) Pub. No.: US 2007/0085509 A1
(43) Pub. Date: Apr. 19, 2007

(54) Method for distributing current to the rectifier valves in inverting converters

(76) Inventors: Wolfgang Schon, Langenargen (DE); Karl-Hermann Ketteler, Markdorf (DE); Andreas Fuessl, Kressbronn (DE); Jurgen Kett, Friedrichshafen (DE); Allan Muschel, Freidrichshafen (DE)

Correspondence Address: DAVIS & BUJOLD, P.L.L.C., 112 PLEASANT STREET, CONCORD, NH, 03301, US

(21) Appl. No.: 11/580,787

(22) Filed: Oct. 13, 2006

(30) Foreign Application Priority Data
Oct. 14, 2005 (DE) 102005049114.6

(51) Int. Cl. H02P 1/46

(52) U.S. Cl. 318/716

(57) ABSTRACT

A method is proposed for distributing current to the existing current directing valves or switches in the inverting converter of adjustment drives with synchronous servo-motors when the end position of the adjustment drive is reached at a time when the torque or force load is high in which the current space indicator of the current is moved electrically through ±90° about the desired end position with sufficient frequency.

This application claims priority from German Application Serial No. 10 2005 049 114.6 filed Oct. 14, 2005.

### FIELD OF THE INVENTION

The present invention concerns a method for distributing current to the existing rectifier valves in the inverting converters of positioning drives with synchronous positioning motors on reaching the end position of the positioning drive at the same time as high torque or force loading.

### BACKGROUND OF THE INVENTION

In asynchronous machines, a certain stator frequency is needed to produce a standstill torque. In this way, in such a case all the semiconductors of the bridge circuit are automatically supplied uniformly with current. However, in synchronous machines the magnetic field at standstill is static so that depending on the position of the rotor, a certain fixed current distribution to the semiconductors is established. The result of this may be that a phase module has to be acted upon by the peak value of the phase current for the electric machine. Especially with low-loss electric machines in which a small standstill voltage is sufficient to drive this current, the free-running path of this phase module is heavily loaded in a disadvantageous manner.

From DE 41 00 864 A1, a method for the control of an electric synchronous motor is known, in which, by applying a rotary voltage to the stator windings of the electric synchronous motor as a function of the rotor position, a rotary magnetic field is produced. The phase of the applied rotary voltage system is shifted as a function of the measured motor load so that at any motor load the torque required for it can be produced with the smallest possible current. This method is intended to increase efficiency.

From DE 42 04 645 A1, a current-limiting circuit for electronically controlled electric motors is known in which the stator current is switched on by electronic power-switching components in specifiable rotation angle ranges in which a timer circuit is provided, which limits the duration of the stator current flow to a value, which does not exceed the specified power limit values of the power-switching components.

The purpose of the present invention is to provide a method for distributing the current to the existing rectifier valves or switches in the inverting converter of regulating drives with synchronous regulation motors when the end position of the regulating drive is reached at a time when the torque or face load is high.

The method according to the invention ensures a uniform distribution of the phase current to all the semiconductor components of the bridge of the synchronous regulation motor. This should also ensure that all the semiconductor valves or switches in the inverting converter must be acted upon with the maximum current well below their thermal time constants.

### SUMMARY OF THE INVENTION

Accordingly, a method for reducing the load on the power electronics is proposed in which the current space indicator of the current is moved electrically through ±90° about the desired end position with a sufficient frequency.

The electrical angular rotation of the current space indicator by 180° (i.e., by ±90° about the desired end position) is achieved by changing the switching position of the power semiconductor.

In addition, angular rotations through 60° (±30°) or 120° (±60°) are also possible. For example, for an angular rotation through 120°, switches 1, 2 and 5, 6 would have to be switched on or off sequentially and, for an angular rotation of 60°, for example, the switches 1, 2 or 5, 6 are switched on or off. Of course, with angular rotations through 60° or 120°, the load reducing effect is less compared with an angular rotation through 180°.

### BRIEF DESCRIPTION OF THE DRAWING

The invention will now be described, by way of example, with reference to the accompanying drawing in which:

FIG. 1 is a schematic representation of the synchronous motor and a switching position of the inverting converter, and

FIG. 2 is a schematic representation of the synchronous motor and another switching position of the inverting converter in FIG. 1 after completion of an angular rotation of the current space indicator through 180° according to the invention

### DETAILED DESCRIPTION OF THE INVENTION

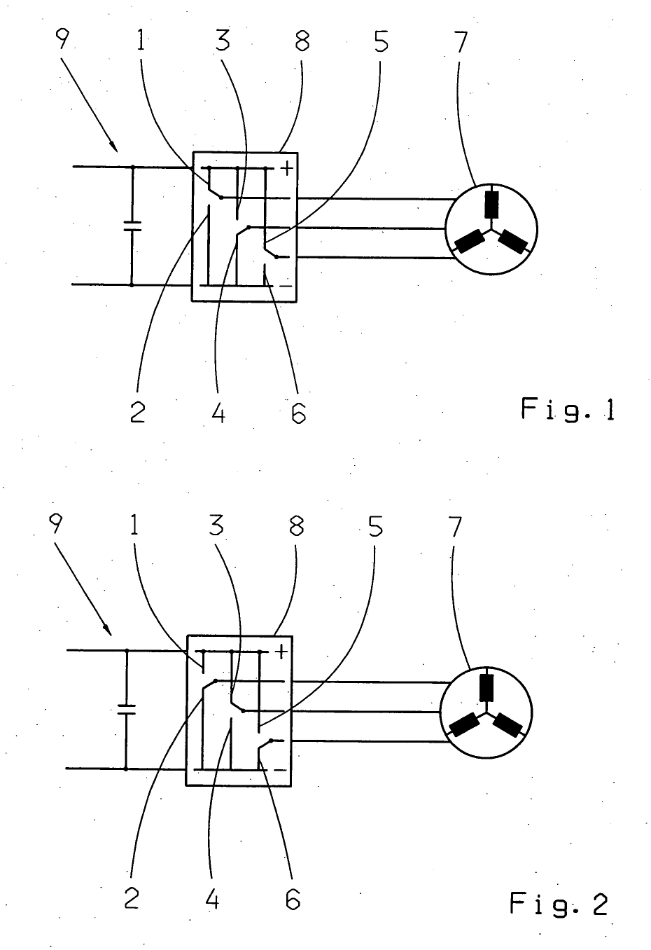

FIG. 1 shows a fixed, unmoved position of an electric motor 7 as an example, in which a fixed switching position of the inverting converter of power electronics 8 is set, an intermediate circuit being indexed as 9; the current flows into the motor 7, via switches 1 and 5 and out again via switch 4. In this case, in particular the switch 4 is heavily loaded.

An electrical angular rotation of the current space indicator through 180° (i.e., through ±90° about the desired end position), in accordance with the method of the invention, is achieved by the exemplified change of the switch positions of the power semiconductor, as represented in FIG. 2.

In this case the switches 1, 4 and 5 of the power electronics 8 are switched off and switches 2, 3 and 6 are loaded, since the current flows into the motor 7, via the switch 3 and flows out via the switches 6 and 2. In the solution according to the invention to be implemented, the current space indicator has to be rotated continuously with all the necessary intermediate positions of the semiconductor switches 1, 2, 3, 4, 5 and 6 through 1800. A continuous rotor movement is also connected with this rotation of the current space indicator. Since in particular synchronous motors with permanent magnets are often made with many poles, the mechanical movement is smaller. If the number of machines is 2 p, the mechanical rotation angle is fₘ=±90°/p.

For example, in a 2p=24-pole electric synchronous machine, the rotation angle amounts to ±7.5°. If this synchronous machine is acting on a spindle for example of 10 mm pitch, the result is an alternating stroke of ±0.21 mm. In many cases this pulsation is acceptable, particularly since it only occurs in an end position at high current and torque loading of a dynamic regulating component.

Thanks to the concept according to the invention, the load on the power electronics system at the end position of regulators with synchronous adjusting motors is reduced in a simple manner, without the need to integrate more components into an existing system.

1-3. (canceled)

4. A method for distributing a current to one of current-directing valves and current-directing switches in an inverting converter of adjustment drives with synchronous servo-motors when an end position of the adjustment drive is reached at a time when one of a torque and a force load is high, the method comprising the steps of:
moving, with sufficient frequency, a current space indicator of the current, electrically through one of ±30°, ±60° and ±90° about a desired end position.

5. A method for distributing a current to one of existing current-directing valves and current-directing switches in the inverting converter of adjustment drives with synchronous servo-motors, the method comprising the step of:
changing a switching position of power semiconductors to achieve an electric angular rotation of a current space indicator through 60°, 120° or 180° (i.e. through ±30°, ±60° or ±90° about a desired end position).

6. A method for distributing current to one of existing current-directing valves and current-directing switches in the inverting converter of the adjustment drives with the synchronous servo-motors, the method comprising the step of:
continuously rotating the current space indicator with all the necessary intermediate positions of semiconductor switches.

7. The method according to claim 4, further comprising the steps of:
rotating, with sufficient frequency, the current space indicator of the current, electrically through one of ±30°, ±60° and ±90° about a desired end position;
changing the switching position of power semiconductors to achieve an electric angular rotation of a current space indicator through 60°, 120° or 180°; and
continuously rotating the current space indicator through all necessary intermediate positions of semiconductor switches.
